(19) United States
(12) Patent Application Publication
(10) Pub. No.: US 2016/0318745 A1
(43) Pub. Date: Nov. 3, 2016

(54) BOTTLE OPENER

(71) Applicant: Paul A. Marcial, Royal Oak, MI (US)

(72) Inventor: Paul A. Marcial, Royal Oak, MI (US)

(21) Appl. No.: 15/143,767

(22) Filed: May 2, 2016

Related U.S. Application Data
(60) Provisional application No. 62/155,756, filed on May 1, 2015.

(51) Int. Cl. B67B 7/16

(52) U.S. Cl. CPC B67B 7/16

(57) ABSTRACT

The present invention includes a bottle opener used to remove a crimped cap from a bottle while retaining the cap in place within the bottle opener. The bottle opener includes a cap remover and a mounting block, the cap remover being mounted onto the mounting block. The cap remover, having an opening formed therein, accepts the cap of the bottle and facilitates the removal of the cap therefrom. The cap remover further includes means for retaining the cap once removed from the bottle. The mounting block includes means for removably mounting the mounting block to a metallic element, disposed opposite the cap remover.

### CROSS-REFERENCE TO RELATED APPLICATION

This application is a completion application and claims priority of co-pending U.S. Provisional Patent Application Serial No. 62/155,756, filed May 1, 2015, for “Bottle Opener,” the entire disclosure of which is hereby incorporated by reference in its entirety including the drawing.

### BACKGROUND OF THE INVENTION

1. Field of the Invention

The present invention relates to bottle openers. More particularly, the present invention relates to surface mountable bottle openers. Even more particularly, the present invention concerns bottle openers with means for retaining a removed cap.

2. Prior Art

As is known to those skilled in the art to which the present invention pertains, many beverage bottles have a crimped cap or top. These crimped caps are ordinarily removed with a bottle opener which leverages the cap between a lip and a support whereby the cap is levered against the lip to remove the cap.

Alternatively, there are hand-held bottle openers which are deployed using the same levering principal.

One of the drawbacks to these present day bottle openers is that they get lost, misplaced, or become difficult to find. Another drawback is the littering that accompanies disposal of the cap when it “flips off” when removed since the user spends little to no time looking for or picking up the cap.

It would be advantageous if such types of bottle openers could be placed or mounted in a permanent fashion in an easily accessible environment and which retains the cap.

It is to this to which the present invention is directed.

### SUMMARY OF THE INVENTION

The present invention provides a bottle opener used to remove a crimped cap from a bottle while retaining the cap in place within the bottle opener. The bottle opener, generally, comprises a cap remover and a mounting block, the cap remover being mounted onto the mounting block. Preferably, the cap remover is screwed onto the mounting block by way of a pair of screws.

The cap remover includes a top plate, a lower support plate, and an opening formed therebetween. The opening is provided in order to accept the cap of the bottle and facilitate the removal of the cap therefrom. The cap remover further includes means for retaining the cap once removed from the bottle. Preferably, the means for retaining comprises a magnet disposed onto the rear of the cap remover and proximate the opening such.

The mounting block includes a front surface, a rear surface, and means for removably mounting the mounting block to a metallic element such as a refrigerator. Preferably, the means for removably mounting is a rubberized and flexible magnet disposed on the rear surface of the mounting block, opposite that of the cap remover.

For a more complete understanding of the present invention, reference is made to the following detailed description and accompanying drawing. In the drawing, like reference characters refer to like parts throughout the several views in which:

### BRIEF DESCRIPTION OF THE DRAWINGS

FIG. 1 illustrates the type of bottle with which the present invention demonstrates particular efficacy;

FIG. 2 is an exploded, perspective view of the bottle opener hereof;

FIG. 3 is a front view of the bottle opener hereof;

FIG. 4 is a rear view of the bottle opener hereof; and

FIG. 5 is a perspective view showing the bottle opener.

### DETAILED DESCRIPTION OF THE INVENTION

At the outset it should be noted that the present invention is contemplated for use with a bottle 22 of the type having an open top neck 23 which is closed with a crimped cap 24.

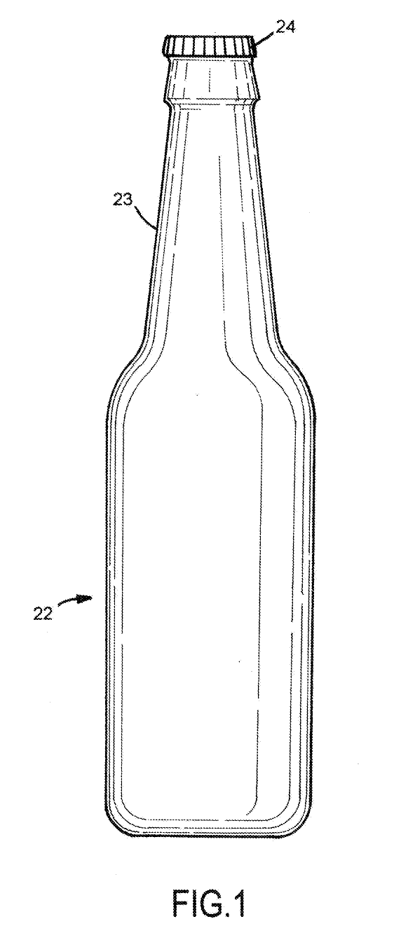

Now, and with reference to FIGS. 1-5 of the drawing, there is depicted therein a bottle opener in accordance with the present invention, generally, denoted at 10.

The bottle opener 10 hereof, generally, comprises a mounting block 12, having a front surface 14 and a rear surface 16, and a cap remover 18 affixed to the front surface 14 of the mounting block 12. Optionally, the bottle opener 10 may include means for removably mounting 20 the bottle opener 10 to a metallic element. The means for removably mounting 20 is secured to the rear surface 16 of the mounting block 12, as discussed below.

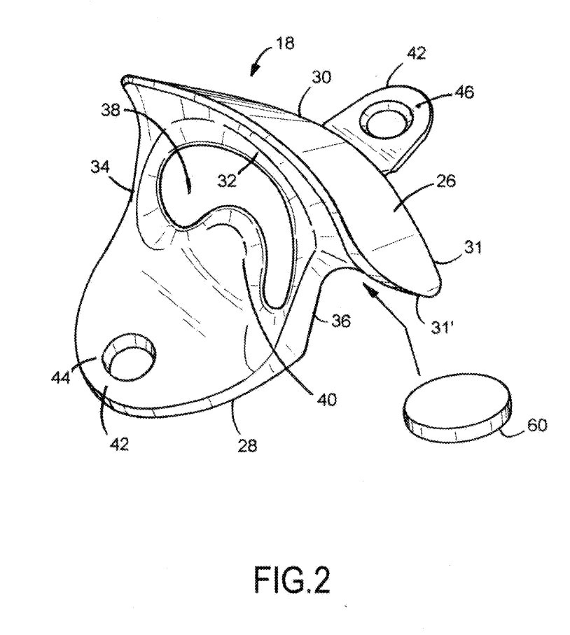

As shown in FIG. 2, the cap remover 18 hereof comprises a sloping arcuate top plate 26 and a lower support plate 28. The plates 26, 28 are integrally formed as a unitary member.

The top plate 26, as shown, comprises an arcuate body 30 having an upper surface 31, a lower surface 31′, a depending lip 32, and a pair of spaced apart legs 34, 36, which are integrally formed and merged with the support plate 28. The legs 34, 36 are spaced apart to provide an opening 38 in which the cap 24 is emplaced.

The support plate 28 is a planar member and includes a projection 40. The projection 40 extends into the opening 38, in opposition to the lip 32, such that the cap 24 may be positioned therebetween.

As is known to those skilled in the art to which the present invention pertains, typically, once the cap 24 is sandwiched in the opening 38, between the lip 32 and the projection 40, the bottle 22 is rotated or levered toward the user to removably lift the cap 24 from the bottle 22.

Means for retaining the cap 24 are disposed on the cap remover 18 proximate the opening 38. Preferably, the means for retaining comprises a first magnet 60. Particularly, the first magnet 60 is a Neodymium magnet. The first magnet 60 is disposed on the lower surface 31′ of the plate 26. The first magnet 60 is secured to the lower surface 31′ of the plate 26 by any suitable means such as an adhesive, fasteners, soldering, and the like. Where an adhesive is used, the first magnet 60 may already include an adhesive backing on one side. This facilitates the cap 24 being retained within the cap remover 18 by being captured or attracted to the first magnet 60, instead of falling to the ground, once the cap 24 is removed from the bottle 22.

Alternatively, the first magnet 60 may be disposed on the rear of the lower support plate 28 or projection 40. While there is flexibility as to the disposition of the first magnet 60 on the cap remover 18, it is essential that it be within proximity of the opening 38 such that the cap 24 is retained once removed.

The bottle opener 10 may further comprise means for securing 42 the cap remover 18 to the mounting block 12. The means for securing 42 includes a pair of flanges or extensions 44, 46 associated with the lower support plate 28 and the top plate 26, respectively.

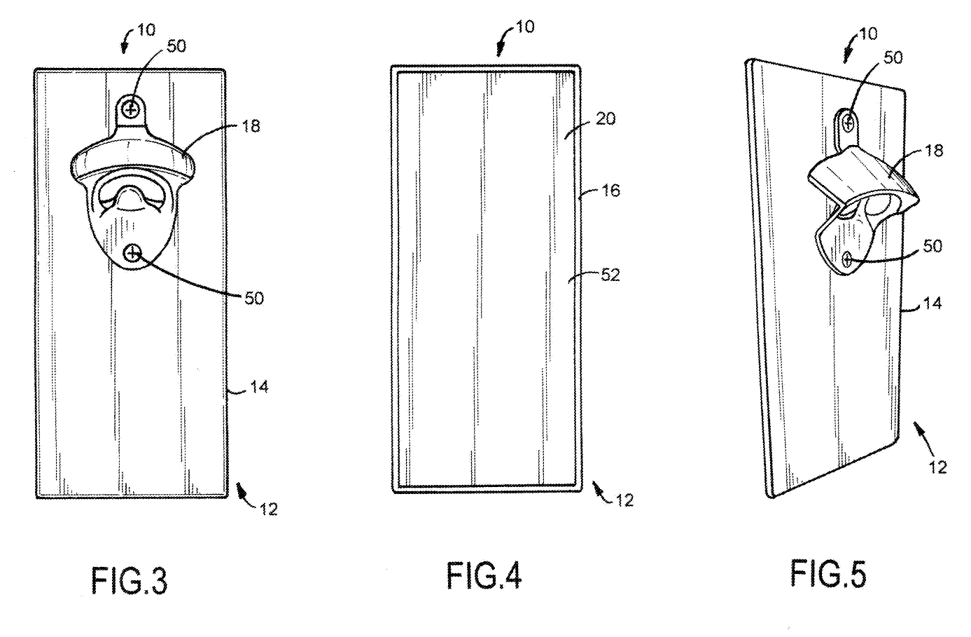

As shown in FIGS. 2 and 3, openings are provided in the flanges 44, 46 and cooperate with fasteners, such as screws 50 and the like, to secure the cap remover 18 to the front surface 14 of the mounting block 12 for support.

The mounting block 12 comprises a lightweight material, such as wood, plastic, and the like, which can have the cap remover 18 secured thereto while being capable of enabling the leveraging of the cap 24 without damaging the structure itself. Preferably, the material that the mounting block 12 is constructed from allows for the mounting block 12 to be cut or otherwise shaped into any variety of custom designs based on the user's requests and provides a surface for custom graphics to be printed thereon. The thickness of the mounting block 12 varies based on the preference of the user. Preferably, the thickness of the mounting block 12 is about 0.5 inches thick. This provides the bottle opener 10 with optimal leverage when used such that the cap remover 18 is closer to the metallic surface or whatever surface the bottle opener 10 is situated on.

As noted above, the means for removably mounting 20 the bottle opener 10 to a metallic element comprises any suitable means such as a magnet, adhesive strip, hook and loop fastener, and the like. Preferably, the means for removably mounting 20 includes a rubberized and flexible second magnet 52 secured to the rear surface 16 of the mounting block 12. Particularly, the second magnet 52 is a 40-millimeter-thick vinyl-based magnet. Having a vinyl-based second magnet 52 creates a less slippery surface and more magnet contact with the metallic surface the bottle opener 10 is adhering to. The second magnet 52 is secured by any suitable means such as an adhesive, staples, screws, and the like. Where an adhesive is used, the second magnet 60 may already include an adhesive backing on one side. The second magnet 52, per se, is well known and commercially available. The second magnet 52 enables removable mounting of the bottle opener 10 to a metallic surface such as a metal cooker, refrigerator door, and the like.

It is to be appreciated that one significant feature of the bottle opener 10 of the present invention is the disposition of the first magnet 60 proximate the opening 38. This deters against littering and the like since the cap 24 is held in place after it is removed from the bottle 22 to provide for easy disposal. Another significant feature is the second magnet 52 being disposed on the rear surface 16 of the mounting block 12 which enables easy mounting of the bottle opener 10 to a metallic surface.

It is to be appreciated from the preceding that there has been described herein a novel cap opener which is easily removably mounted to a metallic surface and which facilitates disposal of a cap by virtue of it being held in place once removed from a bottle.

Having thus described the invention, what is claimed is:

1. A bottle opener used to remove a crimped cap from a bottle, the bottle opener comprising:
(a) a cap remover including a top plate, a lower support plate, and an opening formed therebetween provided for accepting the cap of the bottle, the cap remover further including means for retaining the cap once removed from the bottle, the means for retaining being disposed proximate the opening; and
(b) a mounting block including a front surface, a rear surface, and means for removably mounting the mounting block to a metallic element, the cap remover being mounted onto the front surface of the mounting block, the means for removably mounting being disposed on the rear surface of the mounting block.

2. The bottle opener of claim 1 wherein the means for retaining is disposed proximate the opening.

3. The bottle opener of claim 2 wherein the means for retaining is a first magnet.

4. The bottle opener of claim 3 wherein the first magnet is a Neodymium magnet having an adhesive surface and disposed on the top plate of the cap remover.

5. The bottle opener of claim 3 wherein the first magnet is a Neodymium magnet having an adhesive surface and disposed on the lower support plate of the cap remover.

6. The bottle opener of claim 1 further comprising means for securing the cap remover to the mounting block.

7. The bottle opener of claim 6 wherein the means for securing includes a pair of flanges, each flange extending from the top plate and the lower support plate, each flange having a hole formed therein.

8. The bottle opener of claim 7 wherein at least one fastener secures the cap remover to the mounting block through each of the holes formed in the flanges.

9. The bottle opener of claim 8 wherein the at least one fastener is a pair of screws where each screw secures the cap remover to the mounting block at an associated hole.

10. The bottle opener of claim 1 wherein the mounting block comprises wood.

11. The bottle opener of claim 10 wherein the mounting block is about 0.5 inches thick.

12. The bottle opener of claim 1 wherein the mounting block comprises plastic.

13. The bottle opener of claim 12 wherein the mounting block is about 0.5 inches thick.

14. The bottle opener of claim 1 wherein the means for removably mounting is a second magnet disposed on the rear surface of the mounting block.

15. The bottle opener of claim 14 wherein the second magnet is a rubberized and flexible magnet having a thickness of about 40 millimeters and an adhesive surface.

16. The bottle opener of claim 14 wherein the second magnet is a vinyl-based magnet having a thickness of about 40 millimeters and an adhesive surface.
